(19) United States
(12) Patent Application Publication
(10) Pub. No.: US 2021/0286056 A1
(43) Pub. Date: Sep. 16, 2021

(54) Receiver Arrangement For A Sensor Device

(71) Applicant: Continental Automotive GmbH, Hannover (DE)

(72) Inventors: Niklas Zimmermann, Ulm (DE); Horst Wagner, Santa Barbara, CA (US); Konrad Hirsch, bLAUSTEIN (DE)

(73) Assignee: Continental Automotive GmbH, Hannover (DE)

(21) Appl. No.: 17/249,780

(22) Filed: Mar. 12, 2021

(30) Foreign Application Priority Data
Mar. 12, 2020 (DE) 10 2020 203 191.6

(51) Int. Cl. G01S 7/497; G01S 17/89; G01S 7/4863

(52) U.S. Cl. CPC G01S 7/497; G01S 2007/4975; G01S 7/4863; G01S 17/89

(57) ABSTRACT

Receiver arrangement for a sensor device for recognizing the environment, comprising an optical element which fixes an illuminated region, an apparatus for detecting light, which is arranged in the illuminated region and captures the light of a light source for recognizing the environment, at least one photodiode for recognizing sensor blockages, which is arranged outside of the illuminated region, and a sensor blockage is recognized in that the photodiode captures light which has been scattered outside of the illuminated region by the sensor blockage, wherein an evaluation circuit is situated downstream of the photodiode, which evaluation circuit comprises a transimpedance amplifier.

### FIELD OF INVENTION

The present invention relates to a receiver arrangement for a sensor device , a sensor device for recognizing the environment, a method for recognizing the environment and a vehicle which includes an apparatus in which the environment is recognized on the basis of the method.

### TECHNICAL BACKGROUND

Modern vehicles such as cars, trucks, motorized two-wheeled vehicles or other means of transportation known from the prior art are increasingly being equipped with (driver) assistance systems which can capture the surroundings with the aid of suitable sensor technology or sensor systems, recognize traffic situations and support the driver, e.g., by a braking or steering intervention or by outputting an optical or acoustic warning. Radar sensors, lidar sensors, camera sensors, ultrasonic sensors or the like are regularly deployed as sensor systems for capturing the surroundings. Conclusions regarding the surroundings can subsequently be drawn from the sensor data determined by the sensors. On the basis of said conclusions, generic assistance functions can then be implemented such as, e.g., a lane departure system or Lane Keep Assist (LKA), Emergency Brake Assist (EBA) or Adaptive Cruise Control (ACC).

Generic lidar (light detection and ranging) or ladar (laser detection and ranging) sensors are frequently arranged behind the windshield or in the region of headlights or bumpers of a vehicle in order to optically measure distance and speed. The lidar emits light or laser beams at a fixable angle or in a fixable angular range from a transmitting part or transmitter. The emitted light then strikes objects located in the surroundings, which objects reflect the light beams. The reflections thus backscattered can then be received by a receiving part or receiver of the lidar sensor. The distance from the reflective objects can then be determined, for example, by measuring the time the light takes to travel between the transmitter and the receiver. Such lidar sensors frequently comprise additional translucent covers or plastic body parts in order to protect the lidar sensor, which are referred to as lidome. The sensor components, the lidome or the windshield of the vehicle can, however, be covered or blocked due to contamination or moisture (drops of rain or condensation) (a so-called soft blockage), which leads to an adverse effect on the detection function and, as a result, decreases the functional reliability. Correspondingly, there is a particular interest in developing methods in order to detect and remedy such adverse effects (blockage recognition or detection).

One or more photodiodes or photodiode arrays can further be deployed as (a) light detector(s) on the receiver side in modern lidar sensors. The current coming from the photodiode can be converted and amplified by means of a transimpedance amplifier (TIA or current-to-voltage converter), the input current being converted into a proportional output voltage. The transimpedance amplifier acts as a current-controlled voltage source. The ratio of the output voltage Uₐ to the input current I is expressed as the transimpedance Z (Z in Ohm): Z=Uₐ/I. A generic transimpedance amplifier comprises an operational amplifier which has negative feedback with an ohmic resistance.

A lidar receiver which has an optoelectronic component, e.g., an APD (avalanche photodiode) or a photodetector (PD) and a transimpedance amplifier (TIA) is known from DE 20 2019 103 619 U1. A clipping arrangement for controlling a pulse widening for input currents into the transimpedance amplifier is provided, wherein said input currents are outside of the linear range of the transimpedance amplifier and can supply amplitude information for input currents for the saturation region of the transimpedance amplifier.

### SUMMARY

The problem which therefore forms the basis of the present invention is to provide a generic sensor device having blockage recognition, in which the bandwidth and the dynamic range are increased and the noise susceptibility is decreased.

The receiver arrangement according to example embodiments is provided for a sensor device for recognizing the environment, e.g., a sensor device which can recognize the environment by means of electromagnetic waves, such as light or laser beams, wherein environment recognition within the meaning of the present disclosure is in particular understood to be capturing the surroundings and recognizing objects. A generic sensor device is, e.g., a lidar sensor or a high-flash lidar sensor (HFL). The receiver arrangement includes an optical element which fixes an illuminated region, e.g., by the light refraction and light diffraction characteristics thereof, and an apparatus for detecting light, which is arranged in the illuminated region and captures the light of a light source for recognizing the environment. At least one photodiode for recognizing sensor blockages, however preferably two or more photodiodes for recognizing sensor blockages, is or are provided, which is or are further arranged outside of the illuminated region. A sensor blockage is recognized in that the photodiode captures light which has been scattered outside of the illuminated region by the sensor blockage. In order to evaluate the received light signals, an evaluation circuit is situated downstream of the photodiode, which evaluation circuit includes a transimpedance amplifier. This results in the advantage that the bandwidth and the dynamic range can be increased and the noise susceptibility can be decreased.

The transimpedance amplifier may have a first stage and a second stage, wherein each stage includes a feedback operational amplifier. As a result, the tasks of the transimpedance amplifier can be divided into two. For example, the first stage may include a regular transimpedance amplifier which has a comparatively low transimpedance and a comparatively low amplification and, consequently, a comparatively high bandwidth. The second stage may then include a voltage amplifier which increases the effective transimpedance of the detector so that a sufficient amplification of the current input signals of the photodiode can be attained without adversely affecting the total detector bandwidth.

The fact that the first stage has a lower transimpedance than the product of the first and second stages means that the circuit is in particular also compatible with large photodetector capacitances, while maintaining a sufficiently large signal bandwidth. It can consequently also be used at high input currents, without saturating the transimpedance amplifier.

A transimpedance amplifier can expediently have a differential input, wherein a capacitor or a masked photodiode is arranged parallel to the photodiode in order to recognize a blockage. The capacitance characteristics of the capacitor or of the masked photodiode should correspond at least substantially to the capacitance characteristics of the respective photodiode. As a result, the influence of the signal noise of the photodiode supply can be suppressed or decreased, i.e., the arrangement reacts in an insensitive manner to the noise of the photodiode supply.

A transistor can be advantageously provided at the input of the transimpedance amplifier, via which the input of the transimpedance amplifier becomes conductive with respect to ground, if a certain or fixable signal level (threshold or limit) is exceeded at the output of the amplifier. This limits the maximum input current into the amplifier circuit.

The first stage may include a first and a second signal feedback path which are arranged parallel to one another, wherein the second signal feedback path is configured in such a way that the latter is activated if the diode threshold of the photodiode is exceeded. As a result, the transimpedance can be decreased as soon as the diode threshold or diode forward threshold is exceeded.

For example, such a configuration can be effected in that the resistance of the second signal feedback path is lower than the resistance of the first signal feedback path. In addition, the second signal feedback path may include a diode and/or a transistor and/or another switch valve known from the prior art. The diode threshold or the circuit of the transistor can be configured in such a way that the latter switch as soon as the diode threshold is reached or exceeded.

A focal plane array (FPA) can be expediently provided as an apparatus for detecting light. A focal plane array is an image sensor apparatus which includes, e.g., an arrangement of light-sensitive pixels in a focal plane of a lens. Such arrangements are generally deployed for imaging purposes (e.g., for recording (video) images) or non-imaging purposes (e.g., lidar).

The receiver arrangement is configured in such a way that a sensor blockage can be captured, if the trigger of the blockage is located on the optical element and/or on the lidome and/or on the windshield of the vehicle.

The example embodiments disclose, independently or subordinately, a method for recognizing a blockage of a sensor device for recognizing the environment, in which a sensor device for recognizing the environment is provided, which has a receiver arrangement in particular according to the embodiments. The receiver arrangement includes an optical element, by means of the optical characteristics of which an illuminated region is fixed in the receiver. Light from a light source for recognizing the environment can further be captured via an apparatus for detecting light arranged inside the illuminated region. A sensor blockage is recognized in that a photodiode arranged outside of the illuminated region captures the light which has been scattered outside of the illuminated region by the sensor blockage. According to the embodiments, an evaluation circuit for capturing light is situated downstream of the photodiode or each of the photodiodes, which evaluation circuit includes a transimpedance amplifier.

A sensor device for recognizing the environment is further disclosed, in particular a lidar sensor device or an HFL sensor device, including a transmitting arrangement for transmitting electromagnetic beams, in particular light beams, which are reflected by objects located in the environment of the sensor device, and a receiver arrangement which receives the reflected beams, wherein the environment is recognized on the basis of the received (light) beams. A blockage recognition of the receiver arrangement is provided in order to guarantee the function of the sensor device, wherein the sensor device includes a receiver arrangement according to the example embodiments and/or performs the blockage recognition on the basis of the method according to the embodiments.

In addition, the example embodiments include a vehicle which has environment recognition and is characterized in that a sensor device according to the example embodiments or a method according to the example embodiments is provided for recognizing the environment.

The example embodiments also expressly include combinations of features of the features or claims, so-called sub-combinations, which are not explicitly indicated.

### BRIEF DESCRIPTION OF THE DRAWINGS

The invention is described in greater detail below on the basis of expedient exemplary embodiments, wherein:

FIG. 1 shows a simplified schematic representation of a vehicle, in which a maximum control variable is predicted on the basis of the method according to the example embodiments;

FIG. 2 shows a simplified schematic representation of a lidar receiver arrangement, in which particles are located on the lidome so that light scattering occurs;

FIG. 3 shows a simplified schematic representation of a signal chain for two photodiodes which are arranged at various locations next to the focal plane array;

FIG. 4 shows a simplified representation of a two-stage circuit arrangement according to an example embodiment of a transimpedance amplifier having a photodiode input ending on one side;

FIG. 5 shows a simplified schematic representation of a signal chain having two photodiodes, in which the noise of the photodiode supply is suppressed by a differential input of the transimpedance amplifier;

FIG. 6 shows a simplified representation of a two-stage circuit arrangement according to an example embodiment in which a differential input of the transimpedance amplifier is provided;

FIG. 7 shows a simplified representation of a circuit arrangement for avoiding transimpedance amplifier saturation at strong signal intensities (input current);

FIG. 8 shows a simplified representation of a circuit arrangement for avoiding transimpedance amplifier saturation at strong signal intensities (input current);

FIG. 9 shows a simplified representation of a circuit arrangement for avoiding transimpedance amplifier saturation at strong signal intensities (input current);

FIG. 10 shows a considerably simplified representation of a transfer curve of a receiver arrangement according to the example embodiments, which shows the effectiveness of the dynamic range improvement, and

FIG. 11 shows a representation of a simulated transfer curve which shows the effectiveness of the dynamic range improvement.

### DETAILED DESCRIPTION

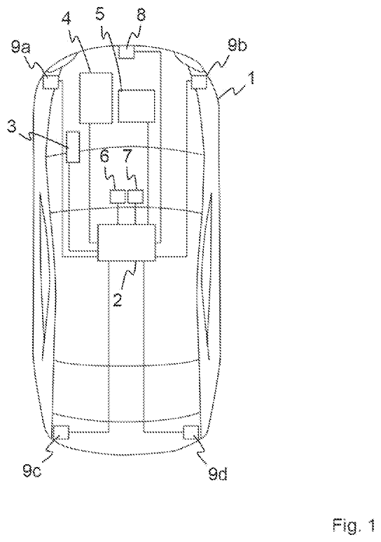

Reference numeral 1 in FIG. 1 designates a vehicle having a control device 2 (ECU, electronic control unit or ADCU, assisted and automated driving control unit) which can carry out a sensor control, sensor data fusion, environment and/or object recognition, trajectory planning and/or vehicle control. In order to control the vehicle, the control device 2 can have recourse to various actuators (steering 3, engine 4, brake 5). The vehicle 1 further has a lidar sensor device 6 and, optionally, further sensors for capturing the environment (camera 7, radar sensor device 8 and ultrasonic sensors 9a-9d). The sensor data can advantageously be utilized for recognizing the environment and objects so that various assistance functions such as, e.g., Emergency Brake Assist (EBA), Automatic Cruise Control (ACC), a lane departure system or Lane Keep Assist (LKA) or the like may be realized. Likewise, the assistance functions may further be executed via the control device 2 or another control unit provided for that purpose.

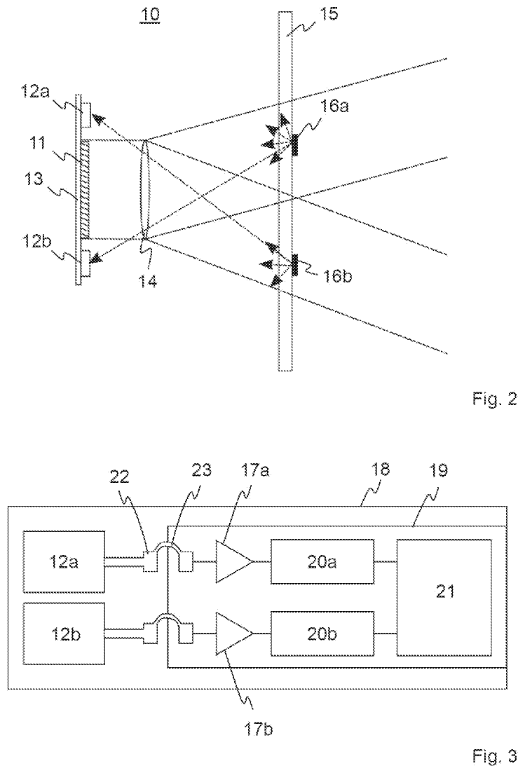

A section of a receiver arrangement 10 according to an example embodiment of the lidar sensor device 7 is represented in FIG. 2. The receiver arrangement 10 includes an FPA (focal plane array) 11 as an apparatus for detecting light, i.e., an arrangement of light-sensitive photodiodes or pixels, and two or more photodiodes 12a, 12b for recognizing sensor blockages or detecting blockages, which are arranged on a carrier 13. The FPA 11 is arranged in the focal plane of the optical element 14, i.e., is located in the illuminated region. The light detection via the FPA 11 is utilized, e.g., in order to receive light signals transmitted by the transmitter, which have been reflected by objects in the surroundings in order to carry out the object detection or distance measurement therewith. The light beams are represented in a simplified manner in FIG. 2 on the basis of arrows, wherein the light focused by the optical element 14 (represented with long dashed strokes) spans the illuminated region, inside which the FPA 11 is arranged.

The photodiodes 12a, 12b for recognizing a blockage are expediently arranged inside the receiver in such a way that light is detected in a region which is not actually illuminated—i.e., is not illuminated by the light source or is no longer located in the focal plane of the optical element 14 but is still located in the capturing range of the reception optics used or of the optical element 14 for focusing light. In addition, the photodiodes 12a, 12b should not be arranged at too great a distance from the illuminated region, so that the sensitivity is not adversely affected. The transmitter of the sensor device or the light source or laser thereof generally serves as the actual light source, wherein this light emitted by the transmitter is reflected by objects in the surroundings so that said objects constitute a light source, the radiated light of which is detected by the receiver.

A lidome 15 is further provided, which, according to FIG. 2, is polluted by particles 16a, 16b, so that the incident light is scattered by these. The light scattered by the particles 16a 16b leads to a back-reflection, wherein light beams are conducted in an unfocused manner through the optical element 14, so that a larger part of the image plane is illuminated by the scattered light, which image plane can then be captured or detected by the photodiodes 12a, 12b. Consequently, the particles 16a, 16b cause a soft blockage of the receiver or of the sensor device. Instead of the lidome 15, another covering element can also be provided such as, e.g., the windshield of the vehicle 1 or the optical element 14.

Consequently, the scattered light can be recognized by the arrangement of the photodiodes 12a, 12b as the light is scattered in the actually blind region next to the FPA 11 and captured by the photodiodes 12a, 12b. As a result, it is established whether the reception optics or the lidome 15 of the lidar sensor is covered or blocked, e.g., by dirt particles (particles 16a, 16b) or raindrops (soft blockage), i.e., such a blocking or contamination is recognized due to the detected scattered light. Conversely, provided that the photodiodes 12a, 12b detect at least substantially no light, no contamination or blockage of the lidome 15 exists. To this end, a specific limit or threshold for the light irradiation captured by the photodiodes 12a, 12b can be provided. Once said limit or threshold is exceeded, a (soft) blockage is to be assumed.

A TIA architecture or a TIA circuit arrangement is advantageously provided for evaluating or reading out the photodiodes 12a, 12b, in which, e.g., a transimpedance (resistance) is applied in a feedback operational amplifier (op-amp or opamp feedback circuit) (TIA or transimpedance amplifier 17), as schematically shown in FIG. 3 on the basis of a signal chain for two photodiodes 12a, 12b. The photodiodes 12a, 12b are arranged on a ceramic assembly 18 which has, in addition, an integrated evaluation circuit or a readout integrated circuit ROIC 19, which includes the downstream TIAs 17a, 17b, samplers 20a, 20b and the standard signal chain 21. The photodiodes 12a, 12b can be connected to the downstream TIAs 17a, 17b, e.g., by means of wire bonding via bonding islands or bonding pads 22 and bonding wire 23. The sampler 20a or 20b and the following signal chain 21 can be identical to the regular pixels on the ROIC (readout integrated circuit). Due to the characteristics of such a TIA architecture, blockage recognition can, however, lead to detrimental effects. For example, due to the large photodiode capacitance which is required, only a limited bandwidth and transimpedance exist and the system responds in a sensitive manner to the noise of the photodiode supply. In addition, due to the cutting out of the signal currents or the clipping of the transimpedance amplifier 17, there only exists a limited dynamic range for large input currents.

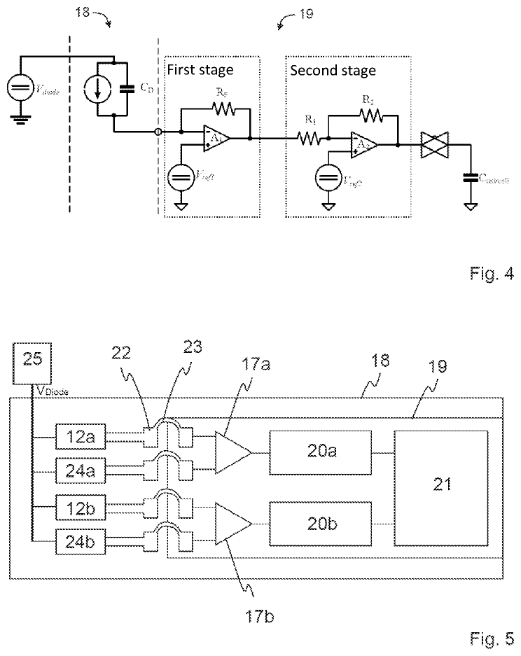

FIG. 4 shows a circuit arrangement having a transimpedance amplifier 17 which is split up into two stages having two operational amplifiers (A₁, A₂) in order to solve the issue of the limited possible transimpedance. The first stage includes a regular transimpedance amplifier having a comparatively low transimpedance (i.e., also low amplification) and, therefore, a comparatively high bandwidth. The second stage substantially includes a voltage amplifier or a voltage amplifier circuit which increases the effective transimpedance of the detector. As a result, a sufficient amplification of the low current input signals of the photodiode (represented on the basis of a photodiode circuit having a capacitance C_{D} on the ceramic assembly 18 and upstream photodiode supply which supplies the diode voltage V_{Diode} on a PCB), without adversely affecting the bandwidth of the detector, i.e., the two-stage configuration is necessary in order to limit the transimpedance RF of the first stage and to, therefore, retain a sufficient bandwidth.

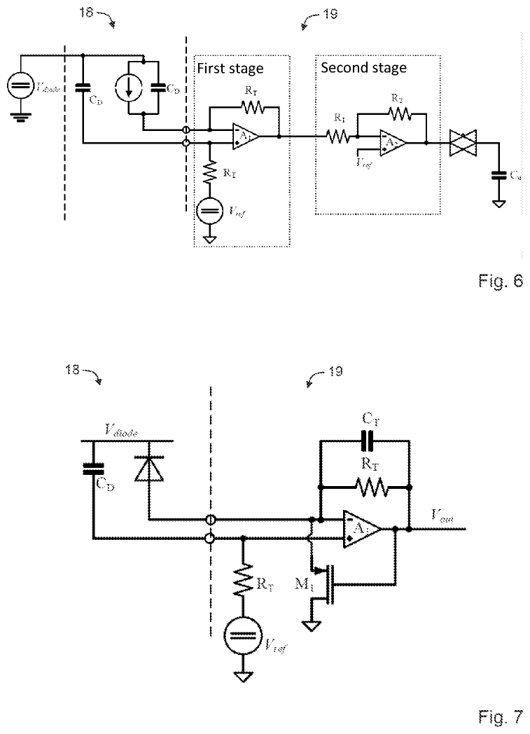

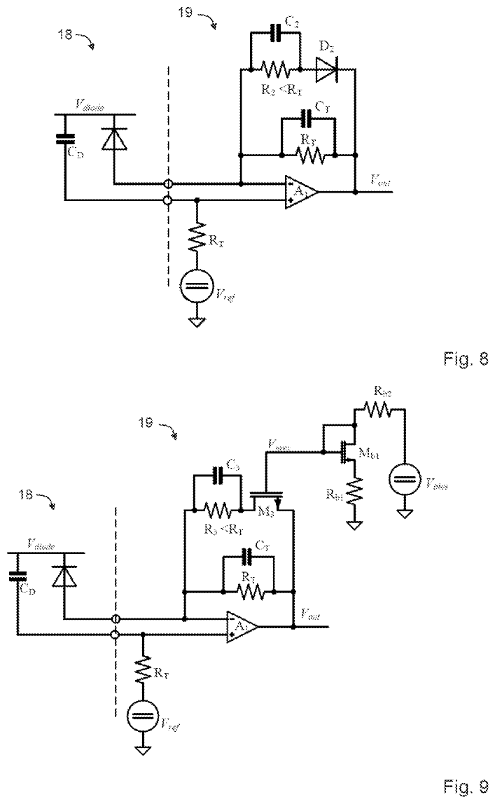

The transimpedance amplifier 17 can, in addition, have a differential input according to FIG. 5 in order to decrease the noise of the photodiode supply 25 or the influence thereof. To this end, a capacitor 24a or 24b having similar capacitance characteristics to the photodiode 12a or 12b is arranged parallel to the active photodiode. In addition, such a circuit arrangement for the photodiode 12a is represented in FIG. 6. The noise at the photodiode supply 25 is coupled in a similar manner to alternating voltage to both inputs of the transimpedance amplifier 17 and suppressed, since it is a common-mode signal, i.e., the noise becomes visible as a common-mode signal at the input of the transimpedance amplifier 17 and is faded out. As an alternative to the capacitor, a masked photodiode can also be deployed. This offers a higher similarity between the capacitances of the photodiode 12a and the masked photodiode and makes possible even better noise suppression. In order to fix as high a dynamic range as possible, in order to decrease the transimpedance at large input currents, multiple mechanisms can be implemented (alone or in combination) such as, e.g., the dissipation of excessive current at the transimpedance amplifier input, if large signal oscillations occur or are recognized (e.g., by means of transistor M₁ according to FIG. 7: if the output voltage Vₒᵤₜ is low by more than one transistor threshold, the current is dissipated via M₁ to GND at the transimpedance amplifier input) or the reduction of the transimpedance by activating a parallel signal feedback path as soon as the diode threshold is exceeded, for example according to FIG. 8 including a resistor R₂, a diode D₂ and a capacitor C₂ connected in parallel to the resistor or, according to FIG. 9, having a transistor M₃ in the triode region instead of the diode D₂ (this solution already functions in the event of an amplitude below a transistor threshold). According to FIG. 8 it is provided that D₂ opens and a parallel transimpedance path is activated parallel to the standard path R_{T}/C_{T}, if the amplitude of Vₒᵤₜ is greater than a diode threshold. R₂ must be low-ohm compared with R_{T} in order to reduce the transimpedance. Due to the arrangement of the capacitance C₂ parallel to R₂, the same frequency response is achieved compared to the standard path R_{T}/C_{T}. Instead of a true diode, the diode-connected transistor M₃ according to FIG. 9 can be used. For example, instead of a diode, e.g., a NMOS transistor (n-type metal-oxide semiconductor or n-channel metal-oxide-semiconductor field effect transistor) is used. The parallel path having lower resistance is already active in the case of signal oscillations of Vₒᵤₜ below the transistor threshold. Advantageously, such a circuit arrangement is more robust, to a large degree, against temperature-related or process-related fluctuations of the threshold voltage in that the bias voltage Vₙᵣₑₛ is tracked with the temperature and process variation. An embodiment of such a bias circuit is shown in the top right of FIG. 9. Alternatively, other implementations are, however, also conceivable such as, e.g., the lowering of a constant current into a NMOS diode.

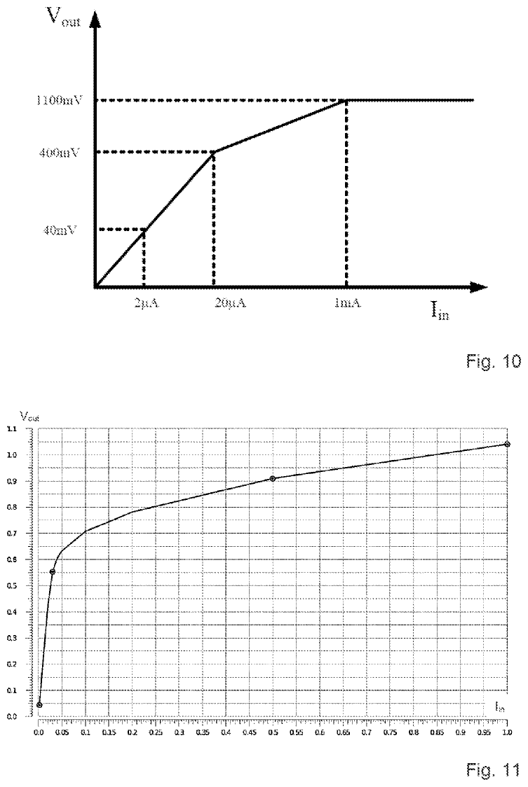

The output voltage is represented in a simplified manner, compared with the input current of a receiver arrangement 10 according to the example embodiments (transfer curve), (e.g., for R_{T}=20 kΩ) in FIG. 10, by plotting the output voltage Vₒᵤₜ against the input current Iᵢₙ. In the case of said idealized transfer curve, the transimpedance is constant up to a specific level (in FIG. 10 up to an input current 20 μA). As of this point, said transimpedance is reduced or has a lower increase. In the case of an input current stage of 1 mA, the excessive current is then guided to earth or ground by the circuit shown in FIG. 7. The output voltage Vₒᵤₜ can, consequently, not rise beyond said point. A simulated output voltage amplitude of Vₒᵤₜ against the input current amplitude of Iᵢₙ for a 3 ns wide laser pulse is further represented in FIG. 11 in order to illustrate the effectiveness of the dynamic range improvement.

### LIST OF REFERENCE NUMERALS

1 Vehicle
2 Control device
3 Steering
4 Engine
5 Brake
6 Lidar sensor device
7 Camera
8 Radar sensor device
9a-9d Ultrasonic sensors
10 Receiver arrangement
11 FPA (focal plane array)
12a Photodiode
12b Photodiode
13 Carrier
14 Optical element
15 Lidome
16a Particle
16b Particle
17 Transimpedance amplifier (TIA)
17a Transimpedance amplifier
17b Transimpedance amplifier
18 Ceramic assembly
19 ROIC
20a Sampler
20b Sampler
21 Standard signal chain
22 Bonding pad
23 Bonding wire
24a Capacitor
24b Capacitor
25 Photodiode supply

1. A receiver arrangement for a sensor device for recognizing the environment, comprising:
an optical element which fixes an illuminated region,
an apparatus for detecting light, which is arranged in the illuminated region and captures the light of a light source for recognizing the environment,
at least one photodiode for recognizing sensor blockages, which is arranged outside of the illuminated region, and
a sensor blockage is recognized in that the photodiode captures light which has been scattered outside of the illuminated region by the sensor blockage, wherein
an evaluation circuit is situated downstream of the photodiode, which evaluation circuit comprises a transimpedance amplifier.

2. The receiver arrangement according to claim 1, wherein the transimpedance amplifier has a first stage and a second stage.

3. The receiver arrangement according to claim 2, wherein the first stage has a lower transimpedance than a product of the two stages.

4. The receiver arrangement according to claim 1, wherein the transimpedance amplifier has a differential input, wherein a capacitor or a masked photodiode is arranged parallel to the photodiode, and wherein capacitance characteristics of the capacitor or of the masked photodiode correspond at least substantially to capacitance characteristics of the respective photodiode.

5. The receiver arrangement according to claim 1, wherein a transistor is provided at an input of the transimpedance amplifier, via which the input of the transimpedance amplifier is connected to ground in order to limit input current when a fixable signal level is exceeded at an output of the transimpedance amplifier.

6. The receiver arrangement according to claim 2, wherein the first stage comprises a first and a second signal feedback path which are arranged in parallel, and the second signal feedback path is configured in such a way that the second signal feedback path is activated if a diode threshold of the photodiode is exceeded.

7. The receiver arrangement according to claim 6, wherein a resistance of the second signal feedback path is lower than a resistance of the first signal feedback path.

8. The receiver arrangement according to claim 6, wherein the second signal feedback path comprises a diode or a transistor.

9. The receiver arrangement according to claim 1, wherein a focal plane array is provided as the apparatus for detecting light.

10. The receiver arrangement according to claim 1, wherein elements triggering the sensor blockage is located on the optical element and/or on a lidome and/or on a windshield of a vehicle on which the receiver arrangement is mounted.

11. A method for recognizing a blockage of a sensor device for recognizing an environment, in which
a sensor device for recognizing the environment, which sensor device has a receiver arrangement, the method comprising:
fixing an illuminated region an optical element of the receiver arrangement,
detecting light by an apparatus arranged in the illuminated region, which apparatus captures the light of a light source for recognizing the environment;
recognizing a sensor blockage in that a photodiode arranged outside of the illuminated region captures light which has been scattered outside of the illuminated region by the sensor blockage; and
capturing or evaluating, by an evaluation circuit, the light, the evaluation circuit is situated downstream of the photodiode, which evaluation circuit comprises a transimpedance amplifier.

12. A sensor device for recognizing an environment, the sensor device comprising:
a transmitting arrangement for transmitting electromagnetic beams which are reflected by objects located in the environment of the sensor device, and
a receiver arrangement which receives the reflected beams, wherein
the environment is recognized on the basis of the received beams, and
a blockage recognition of the receiver arrangement is provided in order to guarantee a function of the sensor device,
wherein
the blockage is recognized on the basis of the method according to claim 11.

13. The sensor device of claim 12, wherein the sensor device comprises a lidar sensor device and the electromagnetic beams comprise light beams.

14. A sensor device for recognizing an environment, the sensor device comprising:
a transmitting arrangement for transmitting electromagnetic beams which are reflected by objects located in the environment of the sensor device, and
a receiver arrangement which receives the reflected beams, wherein
the environment is recognized on the basis of the received beams, and
a blockage recognition of the receiver arrangement is provided in order to guarantee a function of the sensor device,
wherein the sensor device comprises a receiver arrangement according to claim 1.

15. The sensor device according to claim 14, wherein the sensor device comprises a lidar sensor device and the electromagnetic beams comprise light beams.

16. A vehicle which performs environment recognition, the vehicle comprising a sensor device according to claim 12 for recognizing the environment.
